(19) United States
(12) Patent Application Publication
(10) Pub. No.: US 2019/0238732 A1
(43) Pub. Date: Aug. 1, 2019

(54) LENS APPARATUS, IMAGING APPARATUS, IMAGE PROCESSING APPARATUS AND METHOD, AND STORAGE MEDIUM

(71) Applicant: CANON KABUSHIKI KAISHA, Tokyo (JP)

(72) Inventor: Takeshi Watanabe, Saitama-shi (JP)

(21) Appl. No.: 16/256,091

(22) Filed: Jan. 24, 2019

(30) Foreign Application Priority Data
Jan. 26, 2018 (JP) 2018-011730

(51) Int. Cl. H04N 5/225; G06T 9/00; H04N 5/232; G02F 1/137; G02B 7/28

(52) U.S. Cl. CPC H04N 5/2254; G06T 9/00; G02B 7/28; G02F 1/137; H04N 5/23212

(57) ABSTRACT

A lens apparatus includes a focus lens configured to move in focusing, a coding element having a coded area and an uncoded area, and a control element configured to control a state of an optical path of light passing through the coding element.

### BACKGROUND OF THE INVENTION

### Field of the Invention

The present invention relates to an imaging apparatus focusable on an arbitrary object in coding imaging.

### Description of the Related Art

Diego Marcos, “Compressed Imaging by Sparse Random Convolution,” 25 Jan. 2016, Vol. 24, No. 2, DOI:10.1364/OE.24.001269, Optics Express 1269 (“Marcos”) discloses an imaging apparatus that disposes a diffraction grating for forming a wavefront that generates a two-dimensional sparse and random PSF to a diaphragm in an optical system, and captures an image. Japanese Patent Laid-Open No. 2016-90576 discloses an imaging apparatus that branches light from an object into coded light and uncoded light, captures images on respective optical paths, and restores a hyperspectral image based on acquired first and second captured images.

The imaging apparatus disclosed in Marcos needs to set a relationship among an object plane, a lens, a diaphragm, and an image plane in a so-called 4f optical system, and is hard to use for an object located at an arbitrary position. The imaging apparatus disclosed in Japanese Patent Laid-Open No. 2016-90576 captures images on the respective optical paths independently, and cannot provide autofocus on an object located at an arbitrary position in coding imaging.

### SUMMARY OF THE INVENTION

The present invention provides a lens apparatus, an imaging apparatus, an image processing apparatus, an image processing method, and a storage medium, which can provide autofocus on an object located at an arbitrary position in coding imaging.

A lens apparatus according to one aspect of the present invention includes a focus lens configured to move in focusing, a coding element having a coded area and an uncoded area, and a control element configured to control a state of an optical path of light passing through the coding element.

An imaging apparatus according to another aspect of the present invention includes the above lens apparatus, and an image sensor configured to acquire first image data based on light passing through the coded area and second image data based on light passing through the uncoded area.

An image processing apparatus according to another aspect of the present invention includes an inputter configured to input coded image data based on light passing through a coded area in a coding element, an acquirer configured to acquire a coded point spread function corresponding to the light passing through the coded area in the coding element based on an imaging condition of the coded image data, and a restorer configured to generate restored image data from the coded image data using the coded point spread function.

An image processing method according to another aspect of the present invention includes the steps of inputting coded image data based on light passing through a coded area in a coding element, acquiring a coded point spread function corresponding to the light passing through the coded area in the coding element based on an imaging condition of the coded image data, and generating restored image data from the coded image data using the coded point spread function. A non-transitory computer-readable storage medium for storing an image processing program that enables a computer to execute the above image processing method.

Further features of the present invention will become apparent from the following description of exemplary embodiments with reference to the attached drawings.

### BRIEF DESCRIPTION OF THE DRAWINGS

FIG. 1 is a block diagram of an imaging apparatus according to a first embodiment.

FIGS. 2A and 2B explain an operation of an optical path control element according to the first embodiment.

FIGS. 3A to 3C explain an operation (rotational operation) of an optical path control element according to a second embodiment.

FIGS. 4A to 4C explain the operation (insertion and removal operation) of the optical path control element according to the second embodiment.

FIGS. 5A and 5B explain a coding element according to a third embodiment.

FIGS. 6A and 6B explain a light transmittance of the optical path control element according to the third embodiment.

FIGS. 7A and 7B explain a PSF according to the third embodiment.

FIG. 8 explains the coded PSF according to the third embodiment.

FIG. 9 is a flowchart of an image processing method according to a fourth embodiment.

FIGS. 10A and 10B explain sensing matrices according to fourth and fifth embodiments.

FIG. 11 explains the image processing method according to the fourth embodiment.

FIG. 12 is a flowchart of the image processing method according to the fifth embodiment.

FIG. 13 explains the image processing method according to the fifth embodiment.

FIG. 14 explains an estimation result of a spectral distribution of the facial skin according to the fifth embodiments.

### DESCRIPTION OF THE EMBODIMENTS

Referring now to the accompanying drawings, a description will be given of embodiments according to the present invention.

A method called compressed sensing that restores sparsely representable data from physically coded sensing data has been attracted attentions. A variety of illustrative applications using the compressed sensing have been proposed such as a single pixel camera, lens-less imaging, and hyperspectral imaging. One advantage of the compressed sensing is to restore a larger amount of data than an amount of sensing data.

A final result of the data obtained by the compressed sensing is unavailable until the computer executes the restoration processing. The data restoration processing of the compressed sensing often needs a high calculation cost, and is hard to perform on a real-time basis. In other words, it is difficult to view the image acquired in image capturing. The actually acquired image cannot be known until the restoration is made, and it is difficult to use it except for the accurately adjusted setup. A configuration for solving this problem will be specifically described in each of the following embodiments.

### First Embodiment

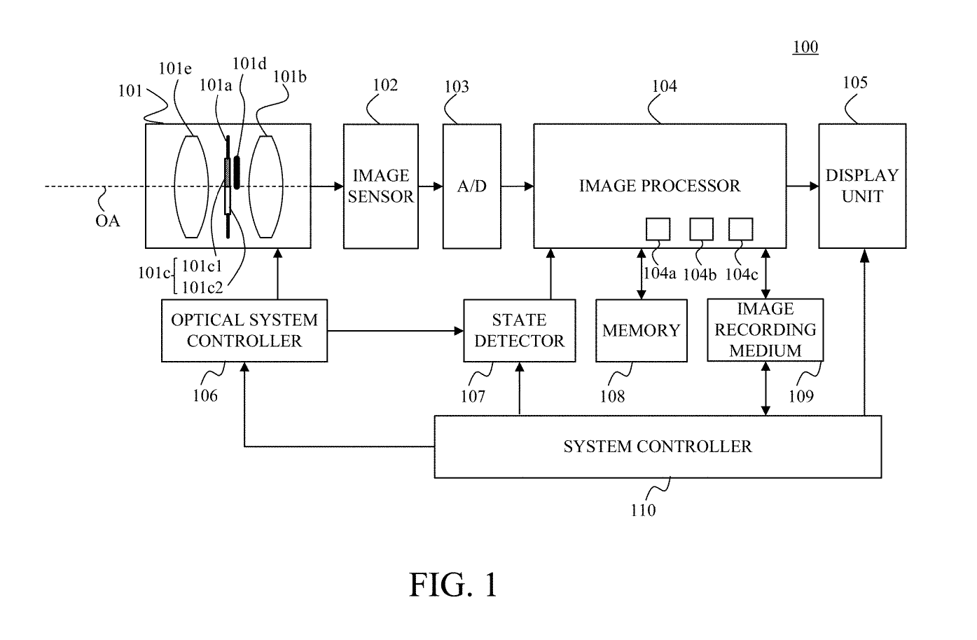

Referring now to FIG. 1, a description will be given of an imaging apparatus according to a first embodiment of the present invention. FIG. 1 is a block diagram of the imaging apparatus 100.

An imaging optical system 101 includes a lens 101e, a diaphragm (aperture stop) 101a, a focus lens 101b that moves in focusing, a coding element 101c, and an optical path control element (control element) 101d. The coding element 101c has a coded area 101c1 and an uncoded area 101c2. In this embodiment, the coded area 101c1 in the coding element 101c is a region to which a random phase is added, and the uncoded area 101c2 is a region to which a random phase is not added. The present invention does not limit the coding element 101c to this example, and may use other configurations as long as the light can be coded (compressed).

The arrangement order of elements (the diaphragm 101a, the focus lens 101b, the coding element 101c, and the optical path control element 101d) in the imaging optical system 101 according to this embodiment is not limited to that illustrated in FIG. 1 and the respective elements may be arranged in a different order. This embodiment disposes the coding element 101c at a position where an (entrance or exit) pupil of the imaging optical system 101 is codable. The coding element 101c may be disposed at a position where no light is shielded (or a light shielding amount is smaller than a predetermined amount) at all image heights (or angles of view) in the imaging optical system 101.

The optical path control element 101d changes the state of the optical path of the light passing through the coding element 101c (or controls the state of the optical path) in focusing and imaging. More specifically, the optical path control element 101d operates to block (shield) the optical path of the light passing through the coded area 101c1 in the coding element 101c in focusing. In imaging, the optical path control element 101d opens only the optical path for the light passing through the coded area 101c1 and blocks (shields) the optical path for the light passing through the uncoded area 101c2. The method of operating the optical path control element 101d is not limited to the above operation method, and other operation methods may be adopted as long as the state of the optical path of the light passing through the coded area 101c1 and the uncoded area 101c2 in the coding element 101c can be controlled. An imaging optical system controller 106 controls each element of the imaging optical system 101 including the optical path control element 101d. A state detector 107 detects the state of the imaging optical system 101 based on the information obtained by the imaging optical system controller 106. A system controller (controller) 110 controls an image processor 104, a display unit 105, the imaging optical system controller 106, the state detector 107, and an image recording medium 109.

The image processor 104 includes an inputter (input unit) 104a, an acquirer 104b, and a restorer 104c. The inputter 104a inputs coded image data (first image data) based on the light passing through the coded area 101c1 in the coding element 101c. The acquirer 104b acquires a coded PSF corresponding to the light passing through the coded area 101c1 in the coding element 101c based on the imaging condition of the coded image data. The restorer 104c generates restored image data from the coded image data using the coded PSF. The inputter 104a further inputs uncoded image data (second image data) based on light passing through the uncoded area 101c2 in the coding element 101c. The acquirer 104b may further acquire the uncoded PSF corresponding to the light passing through the uncoded area 101c2 in the coding element 101c based on the imaging condition of the uncoded image data. The restorer 104c generates the restored image data from the coded image data using the coded PSF and the uncoded PSF. The acquirer 104b may acquire the coded PSF and the uncoded PSF based on the imaging condition corresponding to the state of the imaging optical system 101 focused based on the light passing through the uncoded area 101c2 in the coding element 101c.

The light passing through the imaging optical system 101 can be displayed and observed on the display unit 105 through an image sensor 102, an A/D converter 103, and the image processor 104. The imaging apparatus 100 can perform focusing (focus detection) using a known autofocus function such as a phase difference AF and a contrast AF. The user can provide focusing on a desired (arbitrary) object while observing the display unit 105.

In this embodiment, the image sensor 102 has an opportunity to acquire an optical image (object image) twice. The first time is a sharp optical image in focusing and the second time is a coded optical image. As will be described later, the image sensor 102 acquires first image data based on the light passing through the coded area 101c1 and second image data based on the light passing through the uncoded area 101c2. The system controller 110 performs a focus control based on the second image data and determines a focus position. The image sensor 102 acquires the first image data captured at the determined focus position. Each of these two optical images (the first image data and the second image data) can be recorded as images in the image recording medium 109 or only the coded optical image (first image data) may be recorded as an image in the image recording medium 109. Which recording method is adopted may be selectable by setting a storage mode in the system controller 110.

A memory (storage) 108 previously stores information on a sensing matrix representing a coding characteristic. The restoration (or recovery) processing of the original image can be executed based on an instruction from the system controller 110. When the system controller 110 instructs the image processor 104 to execute the restoration processing, the image processor 104 acquires the sensing matrix that coincides with the (imaging) condition in imaging from the memory 108, and restores the original image from the coded image. The condition in imaging includes a focus position in the autofocus (a focused object position). Assume that y, A, x, and n represent the coded image, the original image, the sensing matrix, and the noises, respectively. Then, the coded image can be modeled as in the following expression (1).

y=Ax+n (1)

Restoring the original image from the coded image means executing estimation processing of the sensing matrix x from the expression (1). Assume that the coded image y and the original image A are known. The restoration processing may be performed using a sharp image in focusing together with the coded image. The image processor 104 estimates the sensing matrix x and records the restored original image in the image recording medium 109. The image restoration processing is not limited to that executed by the image processor 104, and may be executed by a computer or the like outside the imaging apparatus 100.

### Second Embodiment

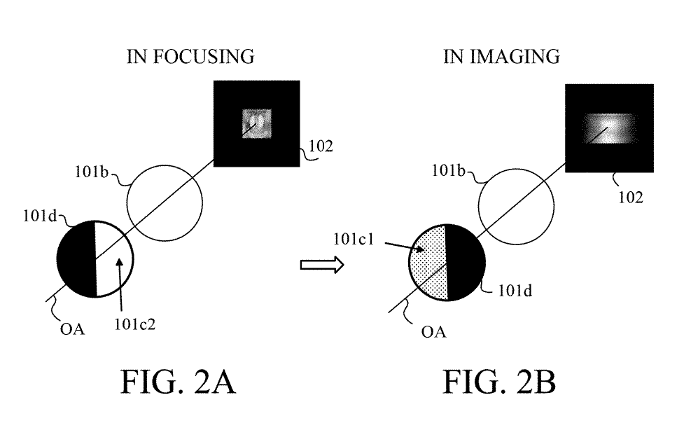

Next follows a description of a second embodiment according to the present invention. FIGS. 2A and 2B explain the operation of the imaging apparatus 100 according to this embodiment. FIG. 2A illustrates the operation of the imaging apparatus 100 in focusing, and FIG. 2B illustrates the operation of the imaging apparatus 100 in imaging.

As illustrated in FIG. 2A, in focusing, the optical path control element 101d moves so as to shield the coded area 101c1 in the coding element 101c from light and to open the uncoded area 101c2 in the coding element 101c. The coding element 101c controls the pupil in the optical system (imaging optical system 101). Hence, the coding element 101c may be disposed on or near the diaphragm 101a in the imaging optical system 101. The imaging optical system 101 according to this embodiment uses an optical system having a low aberration and a small light shielding amount of the pupil for all image heights. The imaging apparatus 100 according to this embodiment divides into two the pupil in the imaging optical system 101 as a coaxial optical system and performs focusing based on the light passing through the pupil of the uncoded area 101c2. The imaging apparatus 100 performs imaging (coding imaging) using the light passing through the pupil of the coded area 101c1 with the focus position fixed. Therefore, the original image can be restored at a high speed for a variety of imaging conditions by previously accurately calculating the sensing matrix of the imaging optical system 101 based on the designed value of the imaging optical system 101.

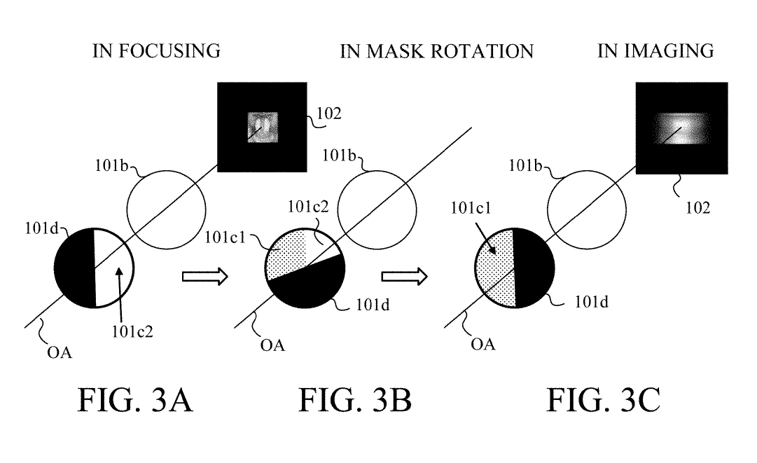

FIGS. 3A to 3C explain the (rotational) operation of the optical path control element 101d according to this embodiment. FIG. 3A illustrates the operation of the optical path control element 101d in focusing, FIG. 3B illustrates the operation of the optical path control element 101d in the rotation of the optical path control element 101d, and FIG. 3C illustrates the operation of the optical path control element 101d in imaging. In this embodiment, the optical path control element 101d is, for example, a light shielding plate (light shielding mask) that rotates around the optical axis OA as a center.

As illustrated in FIG. 3A, in the initial state, the optical path control element 101d (or the rotatable light shielding plate) is disposed on the front surface (or rear surface) of the coded area 101c1 so as to shield the light passing through the coded area 101c1. As illustrated in FIG. 3B, when the imaging apparatus 100 starts autofocusing, the optical path control element 101d (light shielding plate) starts rotating around the optical axis OA. As illustrated in FIG. 3C, when the focus lens 101b stops after the autofocus is executed, the optical path control element 101d (light shielding plate) stops at a position where it has half-rotated from the state of FIG. 3A. The optical path control element 101d is disposed on the front surface (or the rear surface) of the uncoded area 101c2 so as to shield the light passing through the uncoded area 101c2. When the optical path control element 101d is stopped and fixed, the imaging apparatus 100 captures a coded optical image (coded image). After the image is captured, the optical path control element 101d half-rotates and returns to the initial state illustrated in FIG. 3A.

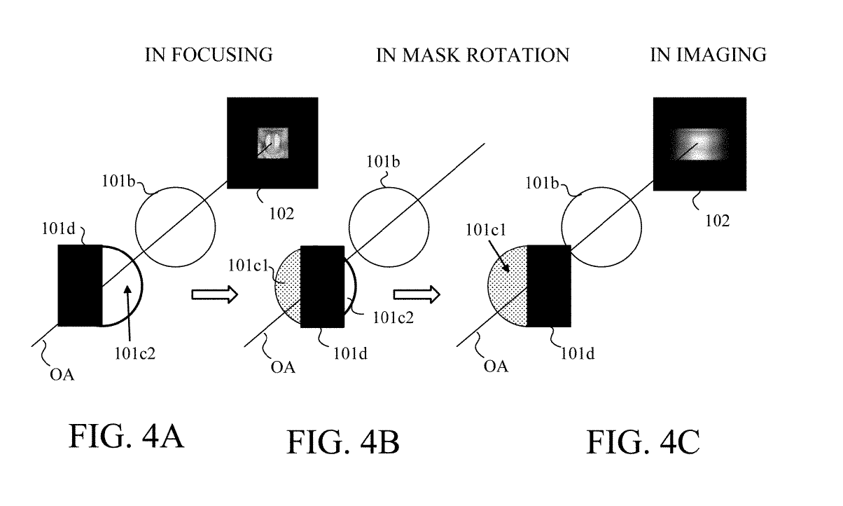

FIGS. 4A to 4C explain the operation (insertion and removal operation) of the optical path control element 101d as a modification of this embodiment. FIG. 4A illustrates the operation of the optical path control element 101d in focusing, FIG. 4B illustrates the operation of the optical path control element 101d when the optical path control element 101d moves, and FIG. 4C illustrates the operation of the optical path control element 101d in imaging. In this modification, the optical path control element 101d is a light shielding plate (light shielding mask) that moves in a direction perpendicular to the optical axis OA.

As illustrated in FIG. 4A, in the initial state, the optical path control element 101d (or the movable light shielding plate) is disposed on the front surface (or rear surface) of the optical path control element 101d so as to shield the light passing through the coded area 101c1. As illustrated in FIG. 4B, when the imaging apparatus 100 starts autofocusing, the optical path control element 101d (light shielding plate) starts moving in a direction perpendicular to the optical axis OA. As illustrated in FIG. 4C, when the focus lens 101b stops after the autofocus is executed, the optical path control element 101d (light shielding plate) stops on the front surface (or rear surface) of the uncoded area 101c2. At this time, the optical path control element 101d is disposed on the front surface (or the rear surface) of the uncoded area 101c2 so as to shield the light passing through the uncoded area 101c2. When the optical path control element 101d is stopped and fixed, the imaging apparatus 100 captures a coded optical image (coded image). After the image is captured, the optical path control element 101d moves in the opposite direction and returns to the initial state illustrated in FIG. 4A.

As described above, in this embodiment, the optical path control element 101d is a light shielding plate rotatable around the optical axis OA or a light shielding plate movable in the direction perpendicular to the optical axis OA, but the present invention is not limited to these examples. For example, the optical path control element 101d may be an element that can shield light under an electrical control, such as a shutter using a polarizing plate and a liquid crystal element, and may have various configurations capable of controlling light transmissions and shields for each region.

### Third Embodiment

Next follows a description of a third embodiment according to the present invention. This embodiment uses a phase element (phase modulation element) having a coded area 101c1 configured to modulate the phase of light as the coding element 101c. It is possible to generate a point spread function (PSF) that changes as the wavelength changes by giving a random phase (in the pupil coordinate) on the pupil plane in the imaging optical system 101 using the coding element 101c. This phase modulation element (coding element 101c) can be realized, for example, by a diffraction grating (random diffraction grating) having a random pupil plane (pupil coordinate) in the height direction. The hyperspectral imaging by the compressed sensing is available with a random diffraction grating. One example is proposed in Michael A. Golub, “Compressed Sensing Snapshot Spectral Imaging by a Regular Digital Camera with an Added Optical Diffuser,” Vol. 55, No. 3, Jan. 20, 2016, Applied Optics. (“Golub”). The method disclosed in Golub enables the snapshot spectral imaging of the object located at a specific position. However, the method disclosed in Golub causes an artifact in the restored image when the object position shifts from the predetermined setup.

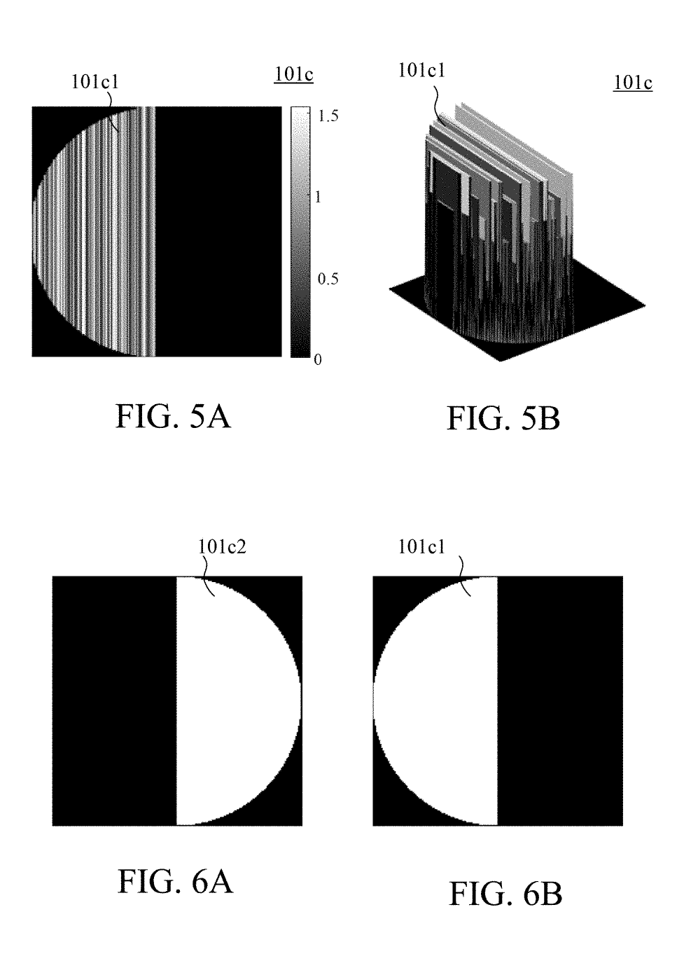

FIGS. 5A and 5B explain the coding element 101c according to this embodiment. FIG. 5A illustrates a random diffraction grating (coding element 101c) that gives a random phase to the coded area 101c1. No random phase is given (or a flat phase is given) to the uncoded area 101c2. FIG. 5A illustrates the random diffraction grating viewed from the optical axis direction, and the value in FIG. 5A is the grating height (grating height) denoted with the micrometer unit. The grating height is determined based on the material and the wavelength band to be spectrally dispersed. In other words, the grating height is determined so that phase modulation of a can be applied at the longest wavelength in the wavelength band of the spectral distribution to be spectrally dispersed. For example, for use in the air (n=1), the grating height is set so as to satisfy the following expression (2).

$$\frac{( {n}_{λ} - 1 ) h}{λ} \approx 1 \qquad ( 2 )$$

In the expression (2), h, λ, and n_{λ} represent the maximum grating height, the longest wavelength, and the refractive index at the longest wavelength, respectively. For example, assume that λ=770 nm and n_{λ}=1.5. Then, h=1.54 μm. The grating pitch may be uniform or nonuniform, but may be determined according to the F-number (aperture value) of the imaging optical system 101. More specifically, as the F-number increases, the grating pitch may be made larger. A height offset may be uniformly added to the diffraction gratings illustrated in FIGS. 5A and 5B by a substrate or the like.

The coding element 101c according to this embodiment divides the pupil of F3.0 into two and sets the coded area 101c1, and the coded area 101c1 is divided into 91. Since the size of the diaphragm 101a in the actual optical system (imaging optical system 101) varies even with the same F-number, this embodiment describes the F-number as a reference. FIG. 5B illustrates a three-dimensional shape of the random diffraction grating. A diffraction grating is provided only to half of the pupil. Such a random diffraction grating can be made of quartz, glass, resin, or the like.

FIGS. 6A and 6B illustrate the light transmittances of the optical path control element (light shielding plate) 101d for the coding element (random diffraction grating) 101c illustrated in FIGS. 5A and 5B. FIG. 6A illustrates the transmittance in focusing (AF), and FIG. 6B illustrates the transmittance in imaging. As illustrated in FIG. 6A, in focusing, the transmittance of the coded area 101c1 in the coding element 101c is low (black), and the transmittance of the uncoded area 101c2 is high (white). On the other hand, as illustrated in FIG. 6B, in imaging, the transmittance of the coded area 101c1 is high (white), and the transmittance of the uncoded area 101c2 is low (black).

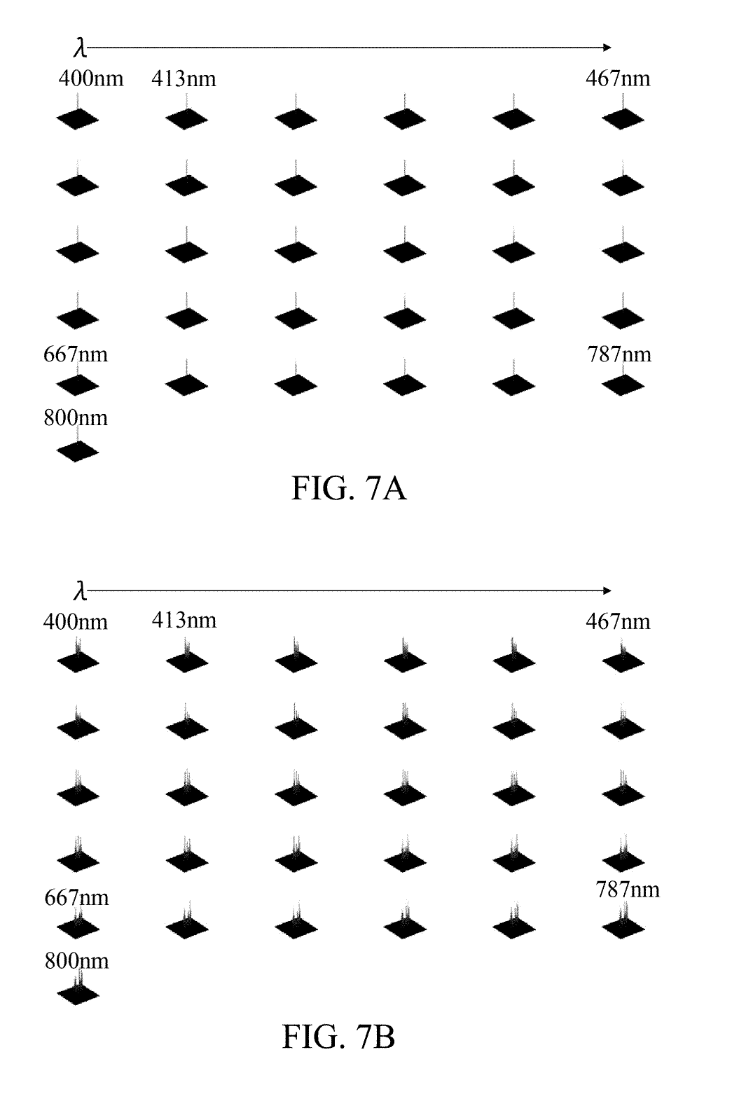

FIGS. 7A and 7B are coded PSFs in imaging which are calculated by the computer simulation. Each PSF is obtained by dividing the wavelength of 400 to 800 nm into 31 parts. FIG. 7A illustrates the uncoded PSF of the light passing through only the uncoded area 101c2, and FIG. 7B illustrates the coded PSF of the light passing through only the coded area 101c1.

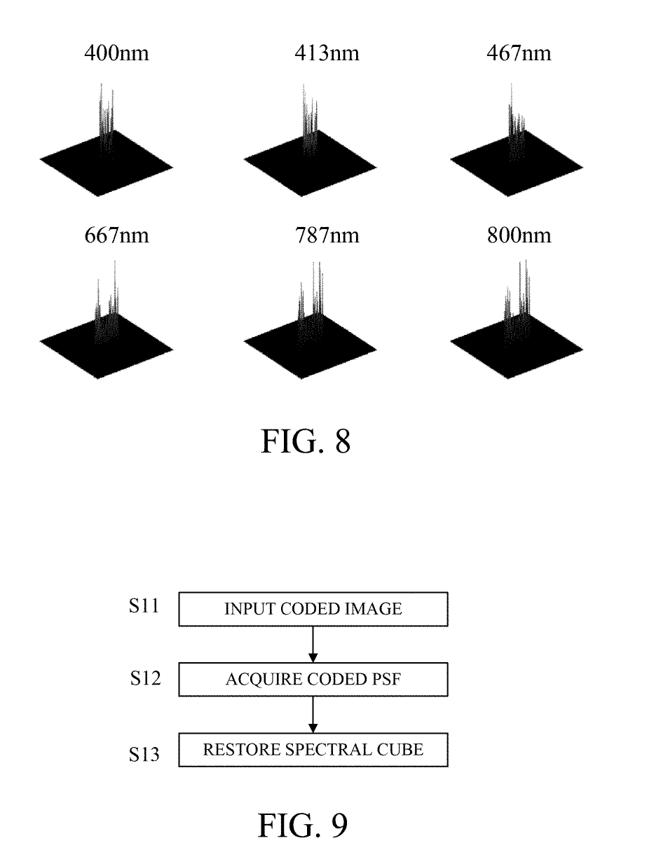

FIG. 8 illustrates PSFs for predetermined wavelengths extracted from the coded PSF illustrated in FIG. 7B. As illustrated in FIG. 8, coding is made such that the cross-correlation of the PSF spatial distribution at each wavelength is low. Since this correlation serves as a factor for determining the wavelength resolution in the subsequent restoration processing, it is necessary to use the image sensor 102 with a pixel pitch that can acquire the spike-shaped PSFs in FIG. 8. The image sensor 102 has a pixel pitch of 3.5 μm in this embodiment.

This embodiment uses an illustrative phase modulation element for the coding element 101c, but can use an amplitude modulation element having a coded area 101c1 for modulating the amplitude of the light. The coded area 101c1 in the amplitude modulation element gives a random amplitude transmittance on the pupil plane (pupil coordinate) in the imaging optical system 101 according to the wavelength of the light. In the coding element 101c, only the region for the phase difference AF may be the uncoded area 101c2. The parameter according to this embodiment is merely illustrative and does not limit the present invention.

### Fourth Embodiment

Next follows a description of a fourth embodiment according to the present invention. Referring now to FIG. 9, a description will be given of an image processing method according to this embodiment. FIG. 9 is a flowchart of the image processing method. Each step in FIG. 9 is mainly executed by each element in the image processor (image processing apparatus) 104 based on a command from the system controller 110. The image processing apparatus according to this embodiment may be an external apparatus (a computer such as a PC) different from the imaging apparatus 100. In this embodiment, for example, the image processor 104 executes the image processing program stored in the memory 108.

First, in the step S11, the image processing apparatus (inputter 104a) inputs (acquires) the coded image. The coded image can contain various imaging conditions in image capturing as header information. The imaging condition in this embodiment contains information on a lens ID used to recognize the imaging optical system 101, a subject distance including a focus in imaging, an F-number as a state of the imaging optical system 101, an element ID of the coding element 101c, and a pixel pitch or the like as information of the image sensor 102. However, the present invention is not limited to this example. The subject distance including a focus in imaging can be calculated based, for example, on the position of the focus lens 101b in the imaging optical system 101.

Next, in the step S12, the image processing apparatus (acquirer 104b) acquires the coded PSF. The coded PSF may be previously prepared and stored in a memory such as the memory 108. There are mainly two methods of preparing the coded PSF. The first method is a method of actually measuring the coded PSF. In particular, the coded PSF suitable for the states of the imaging optical system 101 including the actually used coding element 101c and the image sensor 102 is measured and converted into data. This is an effective method when the optical characteristic of the imaging optical system 101 is unknown. The second method is a method of calculating the coded PSF based on the designed value through the calculation. This is an effective method when the designed values of the imaging optical system 101 including the coding element 101c and the image sensor 102 are available. The coded PSFs may be calculated for a plurality of combinations for various parameters (above parameters such as the lens ID, the subject distance, the F-number, the element ID, and the pixel pitch).

Next, in the step S13, the image processing apparatus (restorer 104c) restores a spectral cube from a decoded image. In order to restore the spectral cube from the coded image, it is necessary to use a coded PSF which coincides with the imaging condition in capturing the coded image. Hence, the previously prepared coded PSF is associated with the imaging condition. The image processing apparatus (acquirer 104b) acquires a coded PSF so that the imaging condition stored in the header information in the coded image coincides with the imaging condition associated with the coded PSF. A coded image, a coded PSF, and a spectral cube can be described by a linear matrix operation expressed by the following equation (3).

y_{c}=A_{c}x (3)

In the expression (3), y_{c}, A_{c}, and x are a coded image, a sensing matrix by a coded PSF, and a spectral cube, respectively. This embodiment restores the spectral cube x using the compressed sensing. The compressed sensing is a sensing method and a restoration algorithm that can be successfully solved for an ill-posed problem by assuming the sparseness of the data. The compressed sensing theory is disclosed in Toshiyuki Tanaka, “Mathematics of Compressed Sensing,” IEICE Fundamentals Review, Vol. 4, No. 1.

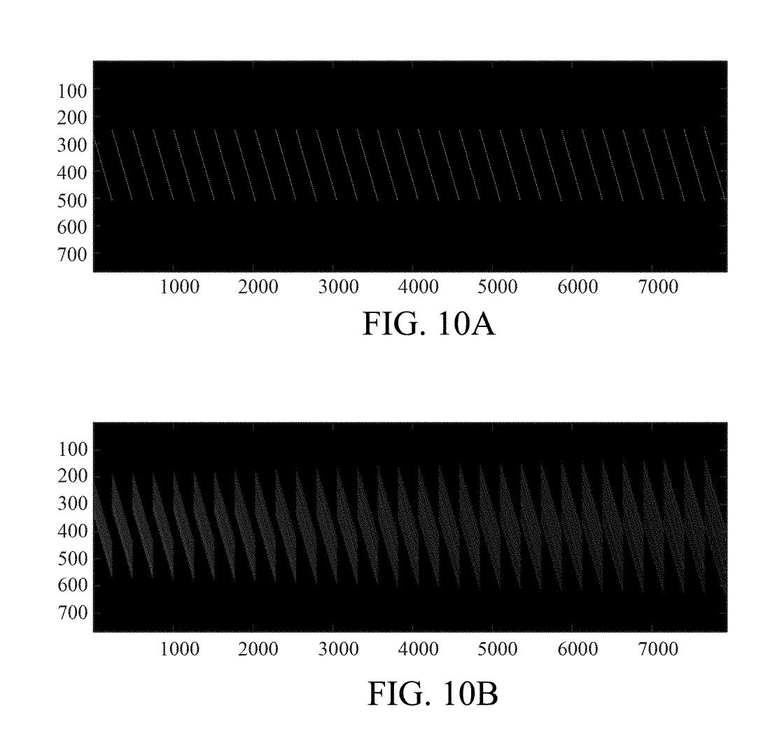

FIGS. 10A and 10B explain the sensing matrix according to this embodiment. FIG. 10A illustrates the PSF transmitted through the uncoded area 101c2 in the coding element 101c in a matrix format, and FIG. 10B illustrates the PSF transmitted through the coded area 101c1 in the coding element 101c in a matrix format. In other words, FIG. 10A illustrates a sensing matrix focused in imaging, and FIG. 10B illustrates a sensing matrix when the imaging apparatus 100 maintains the imaging condition in focusing, operates the optical path control element 101d, and opens the coded area 101c1 in the coding element 101c. FIG. 10B corresponds to a sensing matrix by the coded PSF used for the spectral cube reconstruction according to this embodiment.

The sparseness of the data is to assume that x can be generated from s (a vector with k nonzero elements of s) with k-sparse elements, using Φ representing a proper basis and, for example, a Fourier transform matrix or a wavelet transformation matrix. When they are used, it is assumed that the spectral cube to be restored can be converted into a sparse form. At this time, the following expressions (4) and (5) can be derived by modifying the expression (3).

y_{c}=A_{c}Φ_{S}=K_{S} (4)

x=Φ_{S} (5)

The L0 norm minimum solution of s obtained from the expression (4) is the best solution as a sparse solution. In general, the L0 norm minimum solution is a NP-hard discrete optimization problem. In practice, however, it is known that a sparse solution of s can be obtained even when the L0 norm minimization problem is relaxed to the L1 norm minimization problem. In this embodiment, as expressed by the following expression (6), the L1 norm minimization problem is solved by a regression problem called Lasso for obtaining s.

$${argmin}_{s} \frac{1}{2} {‖ Ks - {y}_{c} ‖}^{2} + λ ‖ s ‖ \qquad ( 6 )$$

The spectral cube x is obtained by substituting s obtained by the expression (6) for the expression (5). The optimization algorithm for solving Lasso at a high speed is disclosed in Jose M. Bioucas-Dias “A New Twist: Two-Step Iterative Shrinkage/Thresholding Algorithms for Image Restoration,” IEEE Transactions On Image Processing, Vol. 16, No. 12, December of 2007.

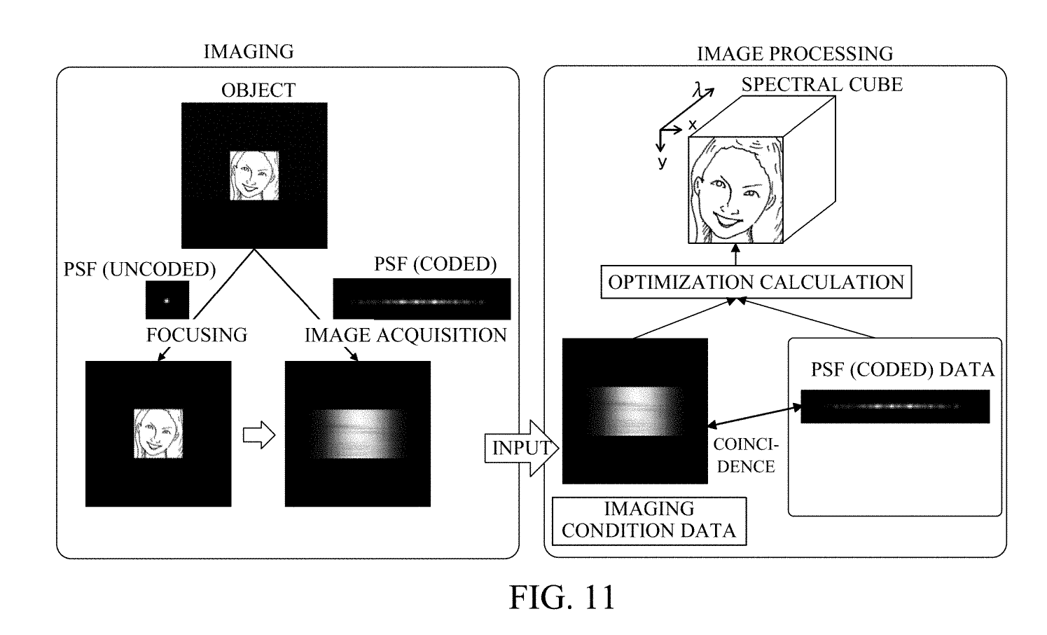

FIG. 11 explains an image processing method according to this embodiment, and specifically illustrates part related to the imaging processing and part related to image processing. The contents described in this embodiment correspond to the part related to the image processing in FIG. 11. The image processing method according to this embodiment can be executed as software or a program running on the PC or implemented as hardware in an image processing engine incorporated into the imaging apparatus 100.

### Fifth Embodiment

Next follows a description of a fifth embodiment according to the present invention. This embodiment uses an uncoded image in addition to the coded image, and can improve the quality of the restored image for the space and wavelength.

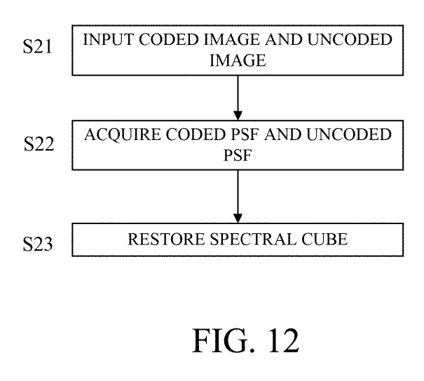

Referring now to FIG. 12, a description will be given of an image processing method according to this embodiment. FIG. 12 is a flowchart of the image processing method. Each step in FIG. 12 is mainly executed by each element in the image processor (image processing apparatus) 104 based on a command from the system controller 110. The image processing apparatus according to this embodiment may be an external apparatus (a computer such as a PC) different from the imaging apparatus 100. In this embodiment, for example, the image processor 104 executes the image processing program stored in the memory 108.

First, in the step S21, the image processing apparatus (inputter 104a) inputs (acquires) the coded image and the uncoded image. The coded image and the uncoded image may store various imaging conditions in image capturing as header information. The imaging condition in this embodiment contains information on a lens ID used to recognize the imaging optical system 101, a subject distance including a focus in imaging, an F-number as a state of the imaging optical system 101, an element ID of the coding element 101c, and a pixel pitch or the like as information of the image sensor 102. However, the present invention is not limited to this example. The information on the imaging condition of the coded image and the uncoded image may be added as header information to individual images, or may be collectively set to the header information.

Next, in the step S22, the image processing apparatus (acquirer 104b) acquires the coded PSF and the uncoded PSF. The coded PSF and the uncoded PSF are previously prepared and stored in a memory such as the memory 108. There are mainly two methods for preparing the coded PSF and the uncoded PSF. The first method is a method of actually measuring the coded PSF. In particular, the coded PSF and uncoded PSF suitable for the states of the imaging optical system 101 including the actually used coding element 101c and image sensor 102 are measured and converted into data. This is an effective method when the optical characteristic of the imaging optical system 101 is unknown. The second method is to calculate the coded PSF and the uncoded PSF from the designed value through the calculation. This is an effective method when the designed values of the imaging optical system 101 including the coding element 101c and the image sensor 102 are available. In this case, the coded PSF and the uncoded PSF can be calculated for a plurality of combinations of various parameters (above parameters such as the lens ID, the subject distance, the F-number, the element ID, and the pixel pitch).

Next, in the step S23, the image processing apparatus (restorer 104c) restores the spectral cube based on the coded image and the uncoded image. In order to restore the spectral cube based on the coded image and the uncoded image, it is necessary to use the coded PSF and the uncoded PSF which coincide with the imaging condition when the coded image and the uncoded image are captured. Hence, the previously prepared coded PSF and the uncoded PSF are associated with the imaging condition. The image processing apparatus (acquirer 104b) acquires the coded PSF and the uncoded PSF so that the imaging condition stored in the header information in the coded image and the uncoded image coincides with the imaging condition associated with the coded PSF and the uncoded PSF. The coded image, the uncoded image, the coded PSF, the uncoded PSF, and the spectral cube can be described by a linear matrix operation represented by the following expressions (7) to (9).

$$\begin{matrix}{y}_{nc} = {A}_{nc} x & ( 7 ) \\ {y}_{nc} = [ \begin{matrix}{y}_{n} \\ {y}_{c}\end{matrix} ] & ( 8 ) \\ {A}_{nc} = [ \begin{matrix}{A}_{n} \\ {A}_{c}\end{matrix} ] & ( 9 )\end{matrix}$$

In the expressions (7) to (9), y_{nc}, A_{nc}, and x are the image matrix having the coded image (y_{c}) and the uncoded image (yₙ) in the submatrix, the sensing matrix having the coded PSF(A_{c}) and the uncoded PSF(Aₙ) in the submatrix, and the spectral cube, respectively.

An illustrative sensing matrix Aₙ by the uncoded PSF used to restore the spectral cube x according to this embodiment corresponds to FIG. 10A, and an illustrative sensing matrix A_{c} by the coded PSF corresponds to FIG. 10B. This embodiment can generate the sensing matrix A_{nc} using these sensing matrices Aₙ and A_{c} as submatrices as in the expression (9).

This embodiment modifies the expressions (7) to (9) based on the sparseness of the data described in the fourth embodiment, and derives the following expressions (10) and (11).

y_{nc}=A_{nc}Φ_{S}=T_{S} (10)

x=Φ_{S} (11)

This embodiment obtains s represented by the following expression (12) and substitutes it for the expression (11) and obtains the spectrum cube x.

$${argmin}_{s} \frac{1}{2} {‖ Ts - {y}_{nc} ‖}^{2} + λ ‖ s ‖ \qquad ( 12 )$$

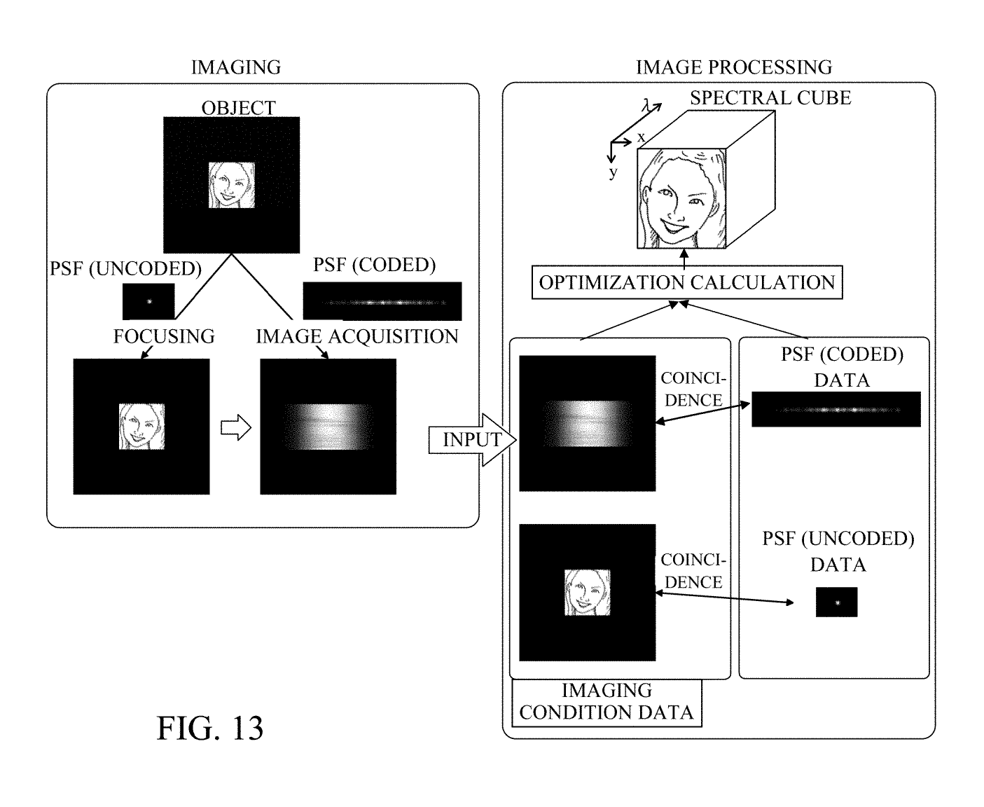

FIG. 13 explains an image processing method according to this embodiment, and specifically illustrates part related to imaging processing and part related to image processing. The contents described in this embodiment correspond to the part related to the image processing in FIG. 13. The image processing method according to this embodiment can be executed as software or a program running on the PC or implemented as hardware in an image processing engine incorporated in the imaging apparatus 100.

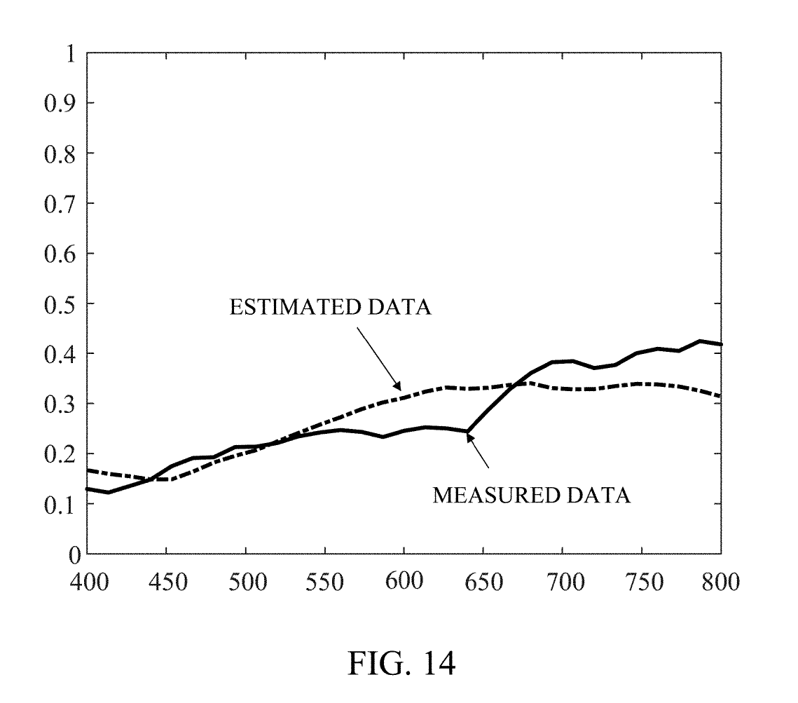

FIG. 14 explains an estimation result of a spectrum distribution of a facial skin on or near a cheek, and illustrates an illustratively restored spectrum of the facial skin on or near the cheek. In FIG. 14, the abscissa axis represents the wavelength (nm) and the ordinate axis represents the spectral value. A line of the estimated data is obtained by plotting spectra at pixel positions on or near the cheek on the face in the wavelength direction based on the spectral cube x restored with the coding element 101c according to this embodiment and the above expression (12). The line of the measured data is actually measured by the spectroscopic measurement.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Each embodiment can provide a lens apparatus, an imaging apparatus, an image processing apparatus and method, and a storage medium, which can realize the autofocus for an object at an arbitrary position in coding imaging.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-011730, filed on Jan. 26, 2018, which is hereby incorporated by reference herein in its entirety.

What is claimed is:

1. A lens apparatus comprising:
a focus lens configured to move in focusing;
a coding element having a coded area and an uncoded area; and
a control element configured to control a state of an optical path of light passing through the coding element.

2. The lens apparatus according to claim 1, wherein the coded area modulates a phase of light.

3. The lens apparatus according to claim 2, wherein the coded area provides a random phase to a pupil plane according to a wavelength of the light.

4. The lens apparatus according to claim 1, wherein the coded area modulates an amplitude of light.

5. The lens apparatus according to claim 4, wherein the coded area provides a random amplitude transmittance to a pupil plane according to the wavelength of the light.

6. The lens apparatus according to claim 1, wherein the control element shields the coded area from light in focusing.

7. The lens apparatus according to claim 1, wherein the control element shields the uncoded area from light in imaging using the lens apparatus.

8. The lens apparatus according to claim 1, wherein the control element is a light shielding plate rotatable around an optical axis.

9. The lens apparatus according to claim 1, wherein the control element is a light shielding plate movable in a direction perpendicular to an optical axis.

10. The lens apparatus according to claim 1, wherein the control element includes a liquid crystal element, and is configured to shield the coded area or the uncoded area from light by electrically controlling the liquid crystal element.

11. The lens apparatus according to claim 1, wherein the lens apparatus is a coaxial optical system.

12. An imaging apparatus comprising:
a lens apparatus according to claim 1; and
an image sensor configured to acquire first image data based on light passing through the coded area and second image data based on light passing through the uncoded area.

13. The imaging apparatus according to claim 12, further comprising a controller configured to perform a focus control based on the second image data and to determine a focus position,
wherein the image sensor acquires the first image data captured at the focus position.

14. An image processing apparatus comprising:
an inputter configured to input coded image data based on light passing through a coded area in a coding element;
an acquirer configured to acquire a coded point spread function corresponding to the light passing through the coded area in the coding element based on an imaging condition of the coded image data; and
a restorer configured to generate restored image data from the coded image data using the coded point spread function.

15. The image processing apparatus according to claim 14, wherein the inputter inputs uncoded image data based on light passing through an uncoded area in the coding element,
wherein the acquirer acquires an uncoded point spread function corresponding to the light passing through the uncoded area in the coding element based on the imaging condition of the uncoded image data, and
wherein the restorer generates the restored image data from the coded image data using the coded point spread function and the uncoded point spread function.

16. The image processing apparatus according to claim 14, wherein the acquirer acquires the coded point spread function based on the imaging condition corresponding to a state of an imaging optical system focused based on the light passing through the uncoded area in the coding element.

17. The image processing apparatus according to claim 15, wherein the acquirer acquires the uncoded point spread function based on the imaging condition corresponding to a state of an imaging optical system focused based on the light passing through the uncoded area in the coding element.

18. An image processing method comprising the steps of:
inputting coded image data based on light passing through a coded area in a coding element;
acquiring a coded point spread function corresponding to the light passing through the coded area in the coding element based on an imaging condition of the coded image data; and
generating restored image data from the coded image data using the coded point spread function.

19. A non-transitory computer-readable storage medium for storing an image processing program that enables a computer to execute an image processing method according to claim 18.
